(19) United States
(12) Patent Application Publication
(10) Pub. No.: US 2006/0026233 A1
(43) Pub. Date: Feb. 2, 2006

(54) Enabling communication between users surfing the same web page

(76) Inventors: Samuel S. Tenembaum, Punta Del Este (UY); Ivan A. Ivanoff, Buenos Aires (AR)

Correspondence Address: DARBY & DARBY P.C., P. O. BOX 5257, NEW YORK, NY, 10150-5257, US

(21) Appl. No.: 10/518,175

(22) PCT Filed: Jun. 17, 2003
(86) PCT No.: PCT/US03/19201

§ 371 Date: Jul. 15, 2005

Related U.S. Application Data
(60) Provisional application No. 60/390,028, filed on Jun. 17, 2002.

(51) Int. Cl. G06F 15/16

(52) U.S. Cl. 709/205

(57) ABSTRACT

A web page is YACHNEE™ enabled by providing an icon on the page which allows actuation upon being clicked. The user is then able to design a character to represent him on the screen. He also sees characters on screen representing other users, which characters have been designed by the users. A user may move his character all over the screen by dragging it with his mouse and may rotate it towards or away from other characters. The characters may speak to each other, either through a voice communication or typing, in which case the text appears in a bubble (cartoon fashion). A user may change the appearance of a character to reflect an emotion (e.g. anger) and he may invite other characters to a private chat. When a user leaves the web page, the corresponding character disappears from all other users' screens. Communication among users viewing the same web page is facilitated without the need for any program or plug-in other than what is standard in a web browser. Additionally, such features as the automatic generation and de-activation of chat-rooms are possible, which in previous applications are pre-defined and independent of the presence of users.

### FIELD OF THE INVENTION

The present invention relates generally to a method for enabling chat and other forms of communication between web surfers visiting the same web page, whether from a computer, a phone or a PDA. This allows for the exchange of opinions and information among such users, which may be presumed to be interested in this exchange by the mere fact that they are on the same web page at the same time. The invention can also be used to match people with similar interests.

### BACKGROUND OF THE INVENTION

Just as computer networks have gained widespread use in business, the Internet (one example of a computer network) has gained widespread use in virtually every aspect of our lives. The Internet is a vast computer network conforming generally to a client-server architecture. The network includes a plurality of interconnected servers (computers) configured to store, transmit, and receive computer information, and to be accessed by client computers. Designated servers host one or more “web sites” accessible electronically through an Internet access provider. A unique address path or Uniform Resource Locator (URL) identifies individual web sites or pages within a web site. Internet users on client computers, utilizing software on a computer (“client software”), may access a particular web site merely by selecting the particular URL. The computers connected to the Internet may range from mainframes to cellular telephones, and they may operate over every conceivable communication medium.

An important aspect of the Internet is the World Wide Web (WWW), a collection of specialized servers on the Internet that recognize the Hypertext Transfer Protocol (HTTP). HTTP enables access to a wide variety of server files, or “content” using a standard language known as Hypertext Markup Language (HTML). The files may be formatted with HTML to include graphics, sound, text files and multi-media objects, among others.

Most users connect to the Internet (or “surf the net”) through a personal computer running an operating system with a graphic user interface (GUI), such as one of the Windows® operating systems. A user communicates over the Internet using a program, called a “browser”, as the client software on his computer. The two most popular browsers are Internet Explorer and Netscape, although many other browsers are in common use. The browser typically receives HTML files and displays “pages”, which may play sound and exhibit text, graphics and video.

Users of the Internet are therefore quite familiar with the browser as a vehicle for surfing the Intemet, but those skilled in the art will appreciate that browsers are not limited to use on the Internet, but are now widely used for general communication on networks, including intranets.

Various programming languages, such as JavaScript, are also available which permit executable code to be embedded in an HTML file and to run when a browser presents the file to the user, thereby performing useful tasks. Additionally, various plug-ins have been developed to extend and expand the capabilities of browsers. Such plug-ins are programs and/or libraries that are used to interpret and execute code that would otherwise be unreadable by the browsers.

Among the plethora of services and tools that were made possible by the Internet and were inconceivable only a few years ago are not only the World Wide Web, but Internet chat. The web contains an ever-growing number of hyperlinked documents addressing all conceivable areas of human knowledge, however s pecific. Chat is a real-time exchange of short text messages, files and graphics among users logged onto the same server. Chat is usually done through either a dedicated chat program or through specialty web pages.

A third type of popular Internet service, called a forum or bulletin board, allows users to gather for discussions and to exchange experiences and opinions regarding a specific subject. The main difference between chats and forums, is the latency between messages: in forums, instead of conversing in real time, users post messages, which are in turn replied to by other users at a later time. The advantage of forums is that users can interact even when they are not available at the same time. Information is accumulated through time, and discussions can build up regardless of the availability of the participants.

The potential of the Internet to connect people with similar interests is key to its success, yet the vast scope of human knowledge makes the matching of these interests a formidable task. On observation of the expanse of the worldwide web (WWW), it is clear that there are millions of locations that are visited by users and millions of users accessing those sites. This creates a logistically complex scenario when it comes to matching people.

Understanding this, it becomes clear that it would be useful and desirable to enable users visiting the same web page to communicate with each other. This capability would allow a connection among those persons that share an interest in the topic discussed in such web page, avoiding the need for research into other venues, like forums and discussion groups.

Enabling the connection of users visiting the same web page would create in situ, spontaneous and time sensitive chat rooms, potentially saving millions of users time that otherwise would be spent doing further research, as well as clearing issues that may not otherwise receive adequate attention.

Several companies have released products aimed at solving this problem, most notably Gooey™. Gooey™ is a plug-in type program that, after being downloaded and installed, allows for the real time interaction of users visiting the same web page, as long as they have the plug-in installed and active. The problem with this approach resides in the need for the plug-in, as well as the need to keep it current with all the available, ever changing operating systems and browsers. As so many failed business models have proven, technology needs to be transparent to the end user in order to be useful on a massive scale.

The present invention, hereafter referred to as YACHNEE™, facilitates communication among users viewing the same web page without the need for any program or plug-in other than what is standard in a web browser. Additionally, the invention includes such novel features as the automatic generation and de-activation of chat-rooms, which in previous applications are pre-defined and independent of the presence of users.

U.S. Patent Application Publication No. US-2002-0052785-A1 and International Publication No. WO 02/21238 A2, the complete contents of which are incorporated herein by reference, disclose a method for introducing to the computer screen of a running program an animated multimedia character that appears on the screen in an intrusive way at times which, to the user, are unpredictable. The character can move over the entire screen and was preferably in the top layer of the display of the browser program, so as not to be covered up by any window or object. It can also provide sound, including speech, music and sound effects.

The present invention expands this concept. In accordance with a preferred embodiment, a web page is YACHNEE™ enabled by providing an icon on the page, which allows YACHNEE™ actuation upon being clicked. The user is then able to design a character to represent him on the screen, or use a standard avatar. He also sees characters on screen representing other users, which characters have been designed by the users. A user may move his character all over the screen by dragging it with his mouse and may rotate it towards or away from other characters. The characters may speak to each other, either through a voice communication or typing, in which case the text appears in a bubble (cartoon fashion) or otherwise. A user may change the appearance of a character to reflect an emotion (e.g. anger) and he may invite other characters to a private chat. When a user leaves the web page, the corresponding character disappears from all other users' screens. If all users leave a chat, it is closed.

The metaphor used by the preferred embodiment to represent users' characters is that of an avatar. Avatars are anthropomorphic figures representing users which, in accordance with the present invention, inhabit a transparent layer or layers in front of the content of the page, which creates an effective chat room. Users can choose the appearance of their avatars, express different emotions with them, walk and interact with other avatars, and many other pre-defined actions. Avatars may display text (i.e.: inside cartoon-like bubbles) or speak in voices, either streaming sound generated by the client or the server, or generated by a local synthesizer.

YACHNEE™ permits a new level of personal interaction on a web page and the following, among other uses:

Chat or other group activities among Internet surfers visiting the same web page at the same time.

The interaction of users via the display of emotionally significant symbols and actions, like fighting, kissing, etc.

Posting of messages a mong Internet surfers visiting the same web page at different times.

Matching of Internet surfers based on dynamic parameters such as surfing habits, consuming patterns, and demographics.

Matching of Internet surfers based on opt-in parameters pre-input by the user (like interests, hobbies, sexual preferences, political sympathies, etc.)

### BRIEF DESCRIPTION OF THE DRAWINGS

The foregoing brief description, as well as further objects, features, and advantages of the present invention will be understood more completely from the following detailed description of a presently preferred, but nonetheless illustrative, embodiment with reference being had to the accompanying drawings, in which:

FIG. 1 is a functional block diagram illustrating the data flow and communication among the various parties in accordance with a preferred embodiment of the method and system of the invention;

FIG. 2 is a flowchart illustrating the preferred log-on process;

FIG. 3 is a flowchart illustrating the preferred client side listener process;

FIG. 4 is a flowchart illustrating the preferred server side listener process;

FIG. 5 is a screen print of a preferred YACHNEE™ enabled work page;

FIG. 6 is a screen print of a web page of FIG. 5 after activation of YACHNEE™; and

FIG. 7 is a schematic block diagram illustrating the preferred configuration of the YACHNEE™ environment on the Internet.

### DETAILED DESCRIPTION OF THE PREFERRED EMBODIMENT

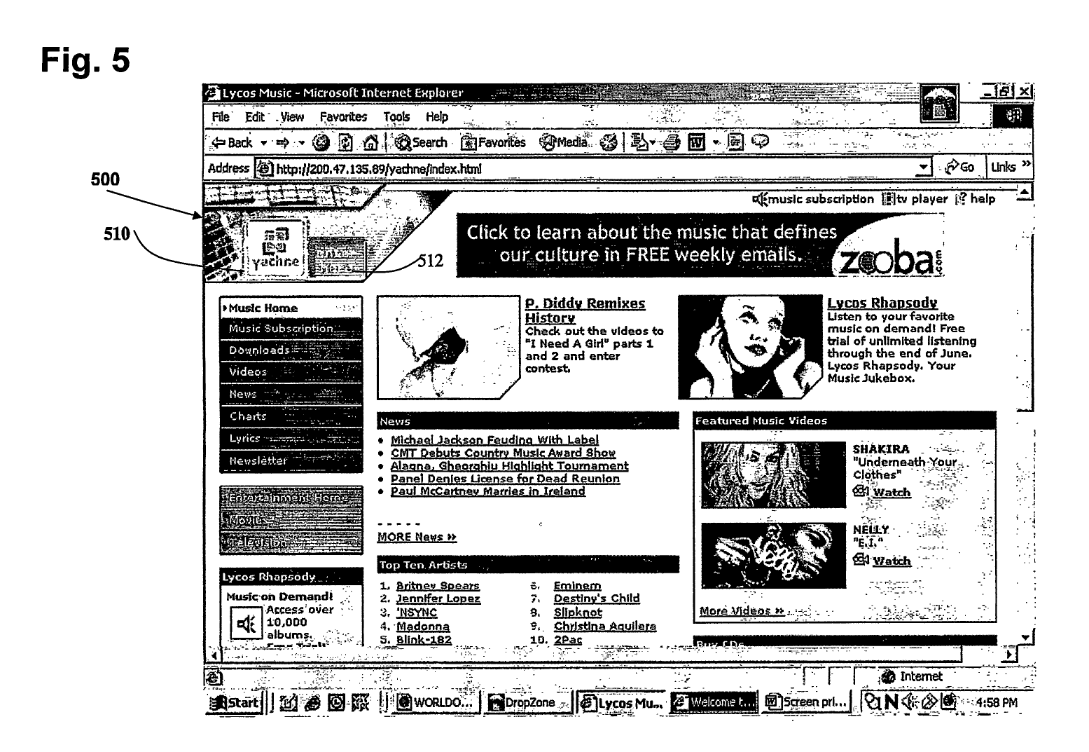

FIG. 5 is a computer screen print illustrating a preferred YACHNEE™ enabled Internet page. The page includes a YACHNEE™ icon 510, including an area 512 that says “enter here.” Should the user double click on area 512, code embedded in the Internet Page will place a call to the YACHNEE™ server. The YACHNEE™ server will download the YACHNEE™ environment to the user, and it will handle all communications between users on the same web page. This log-in process may be skipped and users may enter the Yachne chat without it—opt-in or not.

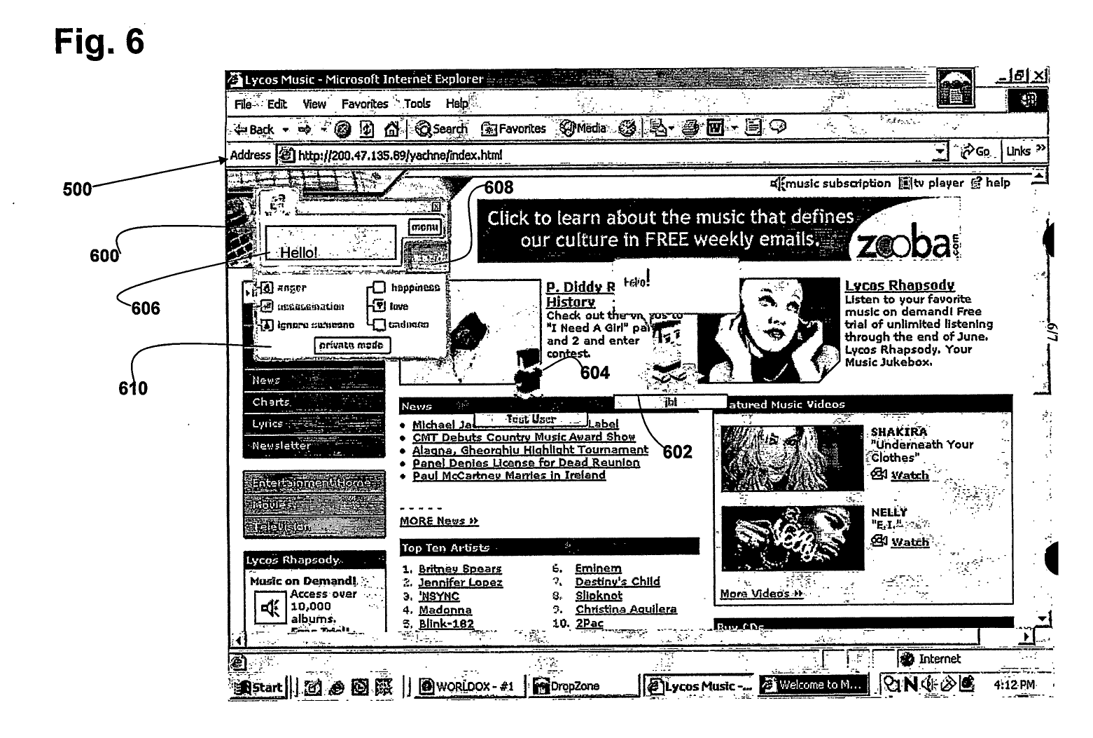

FIG. 6 is a computer screen print illustrating the web page 500 after the YACHNEE™ environment has been installed on the user's computer. Prior to this, the user has designed his avatar after which he is presented with YACHNEE™ menu 600, his avatar 602 (the user's selected screen name is “jbl”), and an avatar representing each user on the same web page. In this example, only one additional user (“test user”) is present, and he is represented by the avatar 604.

Except for the orientation of the avatar 602, the user controls his avatar by making use of the menu 600. Should the user wish to have the avatar speak, he can type a statement (e.g. “Hello!”) in the area 606 and then click on the send area 608. The typed statement will then appear in a bubble next to his avatar. The avatar may also be sound-enabled in which case it would speak the typed statement. By clicking on the appropriate icon in area 610, the user can change the appearance of his avatar to express different emotions. Also, he may click the box indicated as “private mode” to enter a private chat with another user. In FIG. 6, the avatar 604 is ignoring the avatar 602. A user may also control the position of his avatar by dragging it to any point on the screen, and he may control its attitude (the way it faces) with the arrows that appear at the bottom the avatar (e.g. avatar 602).

The YACHNEE™ environment permits users to gather on a webpage, where they are represented by their unique personas. The users may socialize, converse and express emotions through appropriate manipulation of the avatar. The user may exit the YACHNEE™ environment by exiting the menu 600 in the usual manner (e.g. clicking on the x in the upper-right-hand corner).

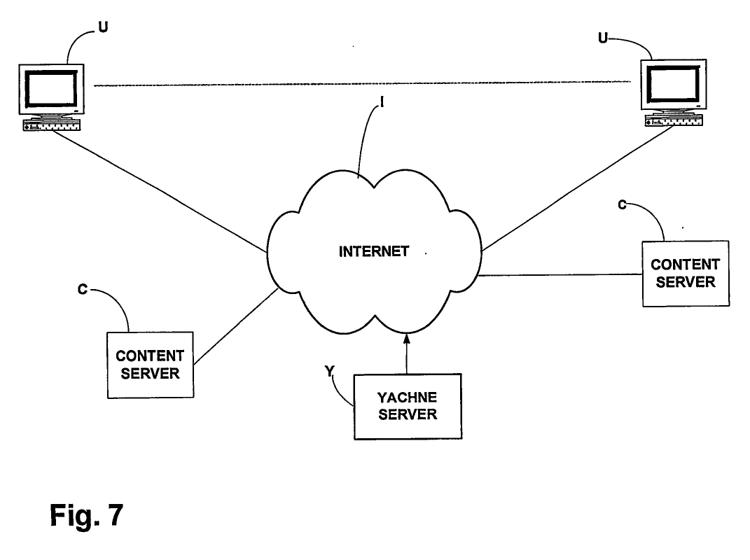

FIG. 7 is a schematic block diagram illustrating the preferred configuration for using the YACHNEE™ environment on the Internet. A plurality of users U and a plurality of content servers C are connected to the Internet, which permits the users to communicate with the content servers. At least one of the content servers is YACHNEE™ enabled and will present a YACHNEE™ icon on its page. When the user clicks on this icon, code provided on the page is executed, and a page is requested for the user from the YACHNEE™ server Y. When this page is received, code on the page executes, to install the YACHNEE™ environment, which includes a chat with the users on the page. Thereafter, any communication related to YACHNEE™ operation is intercepted and handled by the YACHNEE™ server.

The presently preferred embodiment of the invention includes a server side application and a client side agent. In this embodiment, the server side application is written in Java, a programming language developed by Sun Microsystems, which allows for the portability of the application and for its easy installation on a variety of platforms. This is done to facilitate the implementation of YACHNEE™ in various environments, enabling the commercialization of licenses and ease of maintenance.

The client agent in its presently preferred form is programmed in ActionScript, contained inside an. swf file. ActionScript and .swf are, respectively, a scripting language and a file format developed by Macromedia. The playback of such a file and the script code contained in it require the presence of the Flash plug-in, also by Macromedia. The Flash plug-in is widely available and has become a defacto standard for web content authoring and distribution. It is for this reason that it was chosen for this application.

Another reason for utilizing Flash on the client side, besides its compactness and scripting capabilities, is its ability to become both the container of the program logic and the enabler of the display of the Avatars. Flash, on most computers, allows for the control of the opacity of an object, to the extreme of complete transparency, permitting the simulation of objects of all shapes and sizes floating over the content. This is what enables the Avatars to appear over the page and not always be rectangular. It is possible to create a similar effect using DHTML and positioning bit map or vector images on layers controlled by scripting or another method. This can be used on occasions in which the client computer is unable properly to display .swf files with the translucency information. U.S. Patent Application Publication No. US-2002-0052785-A1 and International Publication No. WO 02/21238 A2 delve more deeply into these issues.

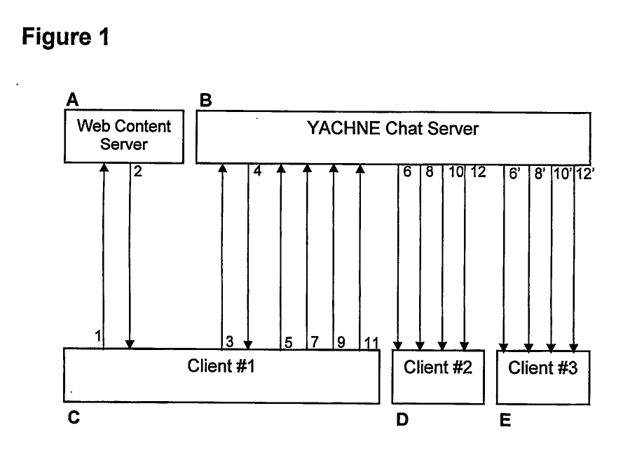

As described further below, with reference to FIG. 1, the client side agent is delivered to the client's computer when he logs onto a web page. Such web page includes an HTML tag pointing to the .swf file hosted in the YACHNEE™ server or any other web server. Upon download, the .swf file is executed by the web browser and initiates the log-on process with the YACHNEE™ application server.

Turning now to FIG. 1, communication 1 is a request for a web page made by client #1 to the Web Content Server A. In response, Web Content Server A delivers an HTML page to client #1 (communication 2). On execution of the HTML document, client #1 requests an .swf file from the YACHNEE™ Server B (communication 3). In communication 4, the .swf file is transferred from YACHNEE™ server B to client #1, after which the .swf file is executed by the client's browser, resulting in a new chat client being defined and communicated to the YACHNEE™ server (communication 5). Communications 6 and 6′ represent the server relaying the existence of client #1 to existing clients #2 and #3, after which a message is sent by client #1 (communication 7). Although the message is directed to clients #2 and #3, it is sent to YACHNEE™ server B. Communications 8 and 8′ show the message from client #1 being passed on to all users connected to the YACHNEE™ server (clients #2 and #3).

If Client #1 changes its position on the web page (e.g. the user drags his avatar to a new position), it sends a communication 9 to the YACHNEE™ Server B. The YACHNEE™ server updates the location of client #1 and spreads the information to all other users, as shown in communications 10 and 10′. When client #1 disconnects, a communication 11 logs him out from the YACHNEE™ server and closes the connection. In communications 12 and 12′, the YACHNEE™ server then informs clients #2 and #3 of the disconnection of client #1.

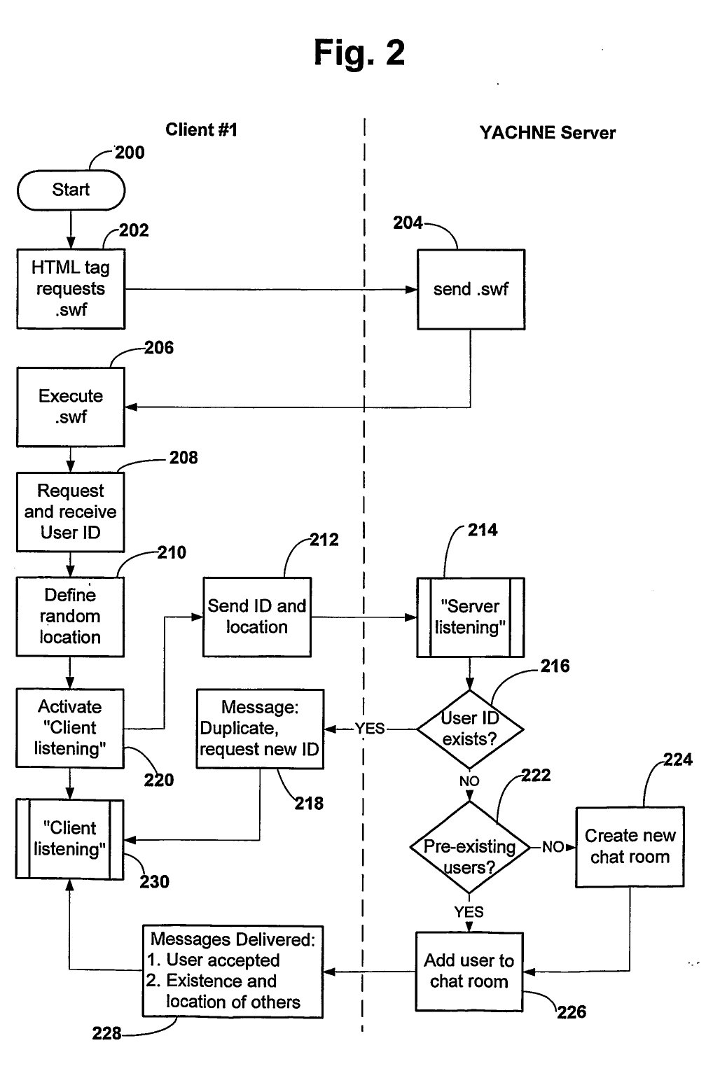

FIG. 2 is a flowchart illustrating the log-on process, for example, by client #1. The process begins at block 200, followed at block 202 by the request for an .swf file from the client to the server. The server responds at block 204, delivering the file to the client. The .swf file is then executed at block 206, initiating the log on process with the user being requested to choose an ID at Block 208. Once the ID is entered, the avatar is given a random screen location at block 210.

Control then transfers to block 220, where the “client listening” process 230 is activated, which listens continuously for incoming server messages. Operation continues at block 212, where the user ID and the avatar's screen location are sent to the server. This message is picked up by the “server listening” process 214, which listens continuously for messages from the clients.

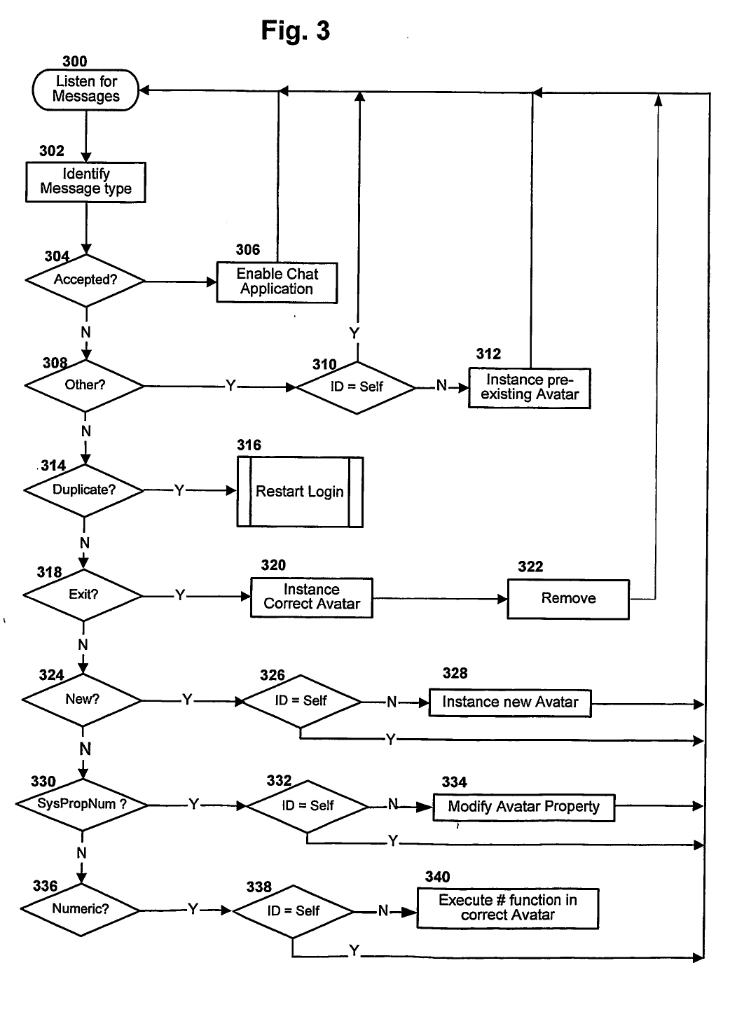

After receiving the client message, the server side application checks whether the name picked by the user has already been assigned to a previous user (block 216). If it has, a message is sent back to the user (block 218) informing him, and the client listening process 230 detects it (see FIG. 3, block 314). If the users name is not duplicated, the process continues at block 222, where the server checks whether there are other users already logged in. If there are not, the process continues at block 224, where a new chat room is created. The process continues, either way, at block 226, where the user is added to the chat room, followed, at block 28 by a message being sent to the client accepting it into the room and identifying the other clients in the chat room. The client listening process 230 receives the message, and the login process ends, leaving the client listening process 230 running.

FIG. 3 is a flowchart illustrating the logic flow of the client side listening process, which begins at block 300, with the listener coming to attention. When a message is received, the client identifies the type of message (block 302). If the message is “accepted” (test at block 304), the process continues at block 306, where the CHAT application is enabled. Control then returns to block 300, where the process awaits a new message.

If the message is not accepted at block 304, operation continues at block 308, where a test is made whether the message is “other.” If so, then operation continues at block 310, where the ID of the user sending the message is checked. If the sender is current user itself, control returns to block 300, where the process awaits a new message. If the sender is other than self, operation continues at block 312, where the appropriate avatar is instanced, after which control returns to block 300, where the process awaits a new message.

If the message is not “other”, the test at block 308 causes operation to continue at block 314, where a test is made to determine if the message is “duplicate.” If so, operation continues at block 316, where control is transferred to the login process (FIG. 2, block 208), while this process returns to block 300, where a new message is awaited. If the test at block 318 indicates that the message is “exit”, the correct avatar is instanced (block 320) and removed (block 322). Control then returns to block 300, where the process awaits a new message.

If the test at block 318 indicates that the message is not “exit”, at block 324, a test is performed to determine if the message is “new.” If so, the sender ID is checked (block 326) and, if it is itself, control is transferred to block 300, where the process awaits a new message. If it is determined at block 326 that the ID is different than self, a new Avatar is instanced (block 328), and control returns to block 300, where the process awaits a new message.

If the test at block 324 indicates that the message is not “new”, a test is performed at block 330, to determine if the message is “SYSPROPNUM” (an indication that the corresponding user has modified an avatar property). If so, the sender ID is checked at block 332 and, if it is itself, control reverts to block 300, where process awaits a new message. If it is determined at block 332 that the ID is different than self, the correct property is modified for the correct avatar (block 334), and control returns to block 300, where the process awaits a new message.

If the test at block 330 indicates that the message is not “SYSPROPNUM”, a test is performed at block 336, to determine if the message is “numeric” (an indication that an avatar function has been performed by the corresponding user). If so, the sender ID is checked at block 338 and, if it is itself, control is transferred to block 300, where process awaits a new message. If it is determined at block 338 that the ID is different than itself, the correct function is executed on the correct avatar (block 340), and control returns to block 300, where the process awaits a new message.

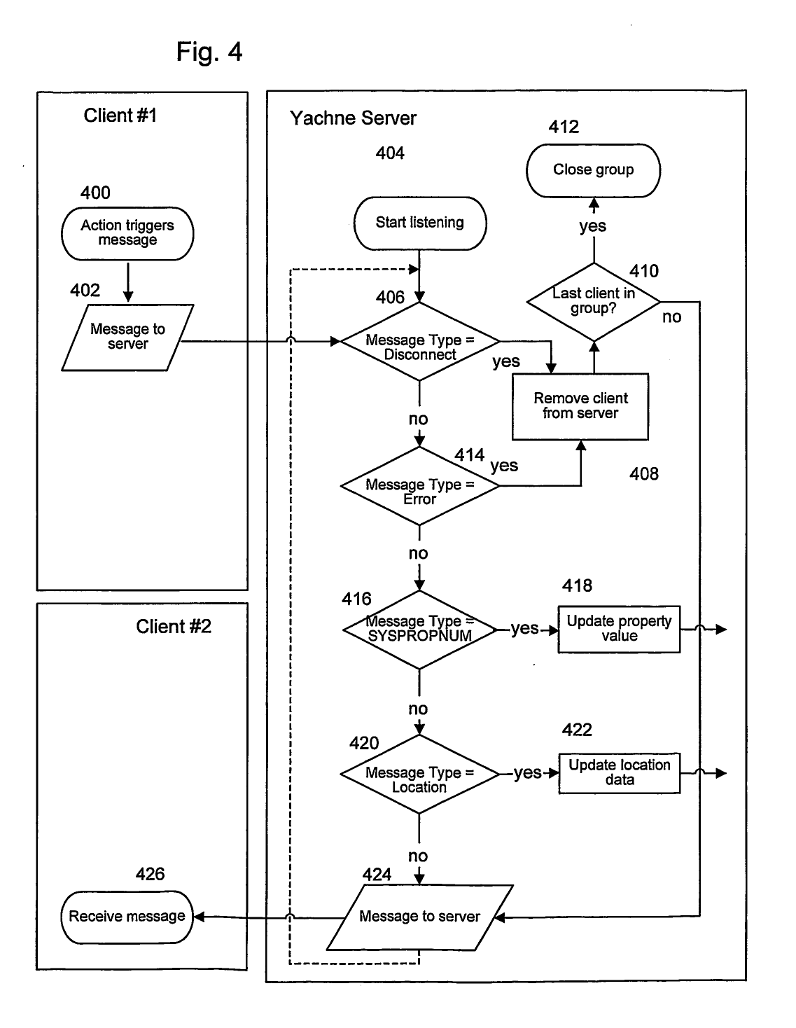

FIG. 4 is a flowchart illustrating the logic flow of the server side listening process. The process begins at block 400, where an action taken by a user (client #1, for example)triggers a message on the user side, which issentto the server (block 402). At block 404, the server side application listens for messages from the users.

At block 406, a determination is made whether the message type received by the server is “disconnect” and, if so, the client is removed from the server (block 408). Operation continues at block 410 where a check is made for the presence of other users. If this is the last user in the group, the group is closed (block 412), and the process ends. Otherwise, the process continues at block 424, where the exit of the user is broadcasted to all remaining users (received at block 426, for example by client #2). Control then transfers to block 404, where the server continues to listen for client messages.

If the test at block 406 indicates that the message is not “Disconnect”, a test is performed at block 414, to determine if the message type is “Error” and, if so, the client is removed from the server (block 408). Operation continues at block 410 where a check is made for the presence of other users is checked. If this is the last user in the group, the group is closed (block 412), and the process ends. Otherwise, the process continues at block 424, where the exit of the user is broadcasted to all remaining users (received at block 426). Control then transfers to block 404, where the server continues to listen for client messages.

If the test at block 414 indicates that the message is not “Error”, a test is performed at block 416, to determine if the message type is “Sysnumprop”, and, if so, the properties database is updated (block 418) and the updated property of the user is broadcasted to all users at block 424 and received at block 426. Control then transfers to block 404, where the server continues to listen for client messages.

If the test at block 416, indicates that the message is not “Sysnumprop”, a test is performed at block 422, to determine if the message type is “Location” and, If so, the location database is updated (block 422), and the updated location of the user is broadcasted to all users at block 424 and received at block 426. Control then transfers to block 404, where the server continues to listen for client messages.

If the test at block 420, indicates that the message is not “Location”, the message is broadcasted to all users at block 424 and received at block 426. Control then transfers to b lock 404, where the server continues to listen for client messages.

Although preferred embodiments of the invention have been disclosed for illustrative purposes, those skilled in the art will appreciate that many additions, modifications and substitutions are possible, without departing from the scope and spirit of the invention. For example, the preferred embodiment of the present invention provides for creating a spontaneous chat room over a web page. It would also be possible to create a forum (a chat room which does not close) by permitting a character to leave a message addressed to another character before exiting the chat room.

1. A method for enabling intercommunication among a plurality of users accessing the same Internet web page, each user accessing the Internet through a respective client computer, the web page operating on a content server computer, the method comprising the steps of, when a first user requests intercommunication service via a first client computer:
sending from a control server to the first client computer a first signal which creates on the first client computer's display of the web page a resident animated character for which the first user controls the appearance, position, movement, and any multimedia output produced by the resident character; and
sending from the control server to the first client computer a second signal which creates on the first client computer's display of the web page a visitor animated character which is entirely out of the first user's control, the control server controlling at least the appearance, position, movement, and any multimedia output produced by the visitor character in accordance with a signal received by the control server from a second client computer.

2. The method of claim 1 wherein the first and second signals install first and second computer subprograms which are executed on the first user's presentation of the web page, the first computer subprogram including a login process which initiates the resident character and a client listening process which remains on the first client computer and responds to incoming signals from the control server.

3. The method of claim 2 wherein the second signal creates a plurality of visitor characters, each controlled by the control server in accordance with a signal received from a different client computer.

4. The method of claim 3 further comprising the step of operating a listening process on the control server which is responsive to a signal received from any client computer.

5. The method of claim 4 further comprising, when the received signal is indicative of a change in appearance, position, movement, or any multimedia output produced by the character corresponding to one of the users, generating a control signal representing the change and sending the control signal to the client computers of the users other than the one user.

6. The method of claim 5 wherein when one of the other users receives the control signal, that user's representation of the character corresponding to the one user is changed accordingly.

7. The method of claim 6 wherein the control server opens a new chat room when an initial user requesting intercommunication enters a web page or when all existing chat rooms corresponding to the web page are full.

8. The method of claim 7 wherein the control server adds a user requesting intercommunication to an existing chat room which is not full.

9. The method of claim 8 wherein the control server closes a chat room when the last user remaining in the chat room exits therefrom.

10. The method of claim 9 wherein the control server opens a private chat room upon the request of a plurality of the users.

11. A control server for enabling intercommunication among a plurality of users accessing the same Internet web page, each user accessing the Internet through a respective client computer, the web page operating on a content server computer, the control server comprising, a signal generator responsive to the request of a first user via a first client computer for intercommunication service, said signal generator producing:
a first signal sent to the first client computer which creates on the first client computer's display of the web page a resident animated character for which the first user controls the appearance, position, movement, and any multimedia output produced by the resident character; and
a second signal sent to the first client computer which creates on the first client computer's display of the web page a visitor animated character which is entirely out of the first user's control, the control server controlling at least the appearance, position, movement, and any multimedia output produced by the visitor character in accordance with a signal received by the control server from a second client computer.

12. The control server of claim 11 wherein the first and second signals are constructed to install first and second computer subprograms which are executed on the first user's presentation of the web page, the first computer subprogram including a login process which initiates the resident character and a client listening process which remains on the first client computer and responds to incoming signals from the control server.

13. The control server of claim 12, wherein the second signal is constructed to create a plurality of visitor characters, each controlled by the control server in accordance with a signal received from a different client computer.

14. The control server of claim 13 further comprising a listening processor on the control server which is responsive to a signal received from any client computer.

15. The control server of claim 14 further comprising a control signal generator cooperating with the listening processor when the received signal is indicative of a change in appearance, position, movement, or any multimedia output produced by the character corresponding to one of the users, said control signal generator generating a control signal representing the change and sending the control signal to the client computers of the users other than the one user.

16. The control server of claim 15 wherein the control signal is constructed so that when one of the other users receives the control signal, that user's representation of the character corresponding to the one user is changed accordingly.

17. The control server of claim 16 further comprising a chat controller which opens a new chat room when an initial user requesting intercommunication enters a web page or when all existing chat rooms corresponding to the web page are full.

18. The control server of claim 17 wherein the chat control is constructed to add a user requesting intercommunication to an existing chat room which is not full.

19. The control server of claim 18 wherein the chat controller is constructed to close a chat room when the last user remaining in the chat room exits therefrom.

20. The control server of claim 19 wherein the chat controller is constructed to open a private chat room upon the request of a plurality of the users.

21. A method for enabling communication between users accessing a web page on a computer network, each user being connected to the network through a respective client computer using an operating system which produces multilayer window images on a computer screen, the web page operating on a content server computer connected to the network, said method comprising the steps of:
creating at least one transparent layer over the display of the web page on the users' computers;
introducing for each user each user an animated character object on the at least one transparent layer;
providing code with each character permitting the corresponding user to control at least one of appearance, position, movement, and multimedia output produced by the respective character;
providing a control server on the network which is in communication with the client computers and relays communications between them;
whereby a chat room for the two users is created over the web page.

22. The method of claim 21 wherein the character objects are objects in the Flash program.

23. The method of claim 22 wherein the character objects are avatars.

24. The method of claim 23 further comprising the step of creating a storage facility in which a character may leave a message for another character.

25. The method of claim 24 wherein the communications relayed by the control server include at least one of: a user's modification of the appearance or position of his character; a user's movement of his character; and a user's creation of multimedia output through his character.

26. The method of claim 1 wherein the second signal creates a plurality of visitor characters, each controlled by the control server in accordance with a signal received from a different client computer.

27. The method of claim 1 further comprising the step of operating a listening process on the control server which is responsive to a signal received from any client computer.

28. The method of claim 1 wherein the control server opens a new chat room when an initial user requesting intercommunication enters a web page or when all existing chat rooms corresponding to the web page are full.

29. The method of claim 1 wherein the control server closes a chat room when the last user remaining in the chat room exits therefrom.

30. The control server of claim 11, wherein the second signal is constructed to create a plurality of visitor characters, each controlled by the control server in accordance with a signal received from a different client computer.

31. The control server of any of claim 11 further comprising a listening processor on the control server which is responsive to a signal received from any client computer.

32. The control server of claim 11 further comprising a chat controller which opens a new chat room when an initial user requesting intercommunication enters a web page or when all existing chat rooms corresponding to the web page are full.

33. The control server of claim 17 wherein the chat controller is constructed to close a chat room when the last user remaining in the chat room exits therefrom.

34. The method of claims 21 further comprising the step of creating a storage facility in which a character may leave a message for another character.

35. The method of claim 21 wherein the communications relayed by the control server include at least one of: a user's modification of the appearance or position of his character; a user's movement of his character; and a user's creation of multimedia output through his character.

36. The method of claim 1 wherein the control server opens a private chat room upon the request of a plurality of the users.

37. The control server of claim 11 wherein the chat controller is constructed to open a private chat room upon the request of a plurality of the users.
